(19) United States
(12) Patent Application Publication
(10) Pub. No.: US 2023/0360068 A1
(43) Pub. Date: Nov. 9, 2023

(54) EVALUATING ENTITY BEHAVIOUR IN A CONTRACTUAL SITUATION

(71) Applicant: ADVENCO HOLDINGS PROPRIETARY LIMITED, Port Louis (MU)

(72) Inventors: Emli-Mari NEL, Ermelo (ZA); Pieter Andries VENTER, Ermelo (ZA); Elizabeth VENTER, Ermelo (ZA); Jan Hendrik VENTER, Ermelo (ZA)

(73) Assignee: ADVENCO HOLDINGS PROPRIETARY LIMITED, Port Louis (MU)

(21) Appl. No.: 18/040,377

(22) PCT Filed: Aug. 5, 2021
(86) PCT No.: PCT/IB2021/057203

§ 371 Date: Feb. 2, 2023

(30) Foreign Application Priority Data
Aug. 5, 2020 (ZA) 2020/04843

(51) Int. Cl. G06Q 10/067; G06Q 30/0203

(52) U.S. Cl. CPC G06Q 30/0203; G06Q 10/067

(57) ABSTRACT

A computer-implemented method and system are provided for evaluating entity behaviour in a contractual situation, wherein the contractual situation is between contracting entities. The method includes receiving initial survey input data from a user computing device on behalf of a contracting entity in the form of response data prompted by a series of questions. The method models the entity behaviour using a behaviour model based on the initial survey input data to obtain an output predicted behaviour of the entity. The method further includes receiving evidence input data from data sources relating to the contractual situation and gathered during a contractual time period and updating the modelling of the entity behaviour based on the evidence input data to migrate the output predicted behaviour to an output evidence-based behaviour.

### CROSS-REFERENCE TO RELATED APPLICATIONS

This application claims priority from South African complete patent application number 2020/04843 filed on 5 Aug. 2020 which is incorporated by reference herein.

### FIELD OF THE INVENTION

This invention relates to evaluating entity behaviour in a contractual situation. In particular, the invention relates to modelling entity behaviour based on survey input data and evidence input data gathered over time.

### BACKGROUND TO THE INVENTION

Contractual situations arise in a large number of situations in day-to-day life where a contract or agreement is entered into between two or more parties. The contract may be written, verbal or simply implied by receiving a service. The parties’ behaviour in such contractual situations is important to evaluate at the outset. However, it is often difficult to evaluate as the parties may be unknown and untested.

There are various known situations in which feedback is obtained based on parties past behaviour. Subjective feedback may be provided and used by later users in online services such as online holiday rentals or online taxi services. These are examples of platforms that use this feedback to provide additional information on certain subjects to their users. It is however biased feedback and users have to spend a lot of time reading through good and bad reviews to be able to form a holistic opinion.

Health insurance companies may use incentive systems to drive certain behavioural outcomes for their policyholders. A score is based on actual events that can be logged and validated such as going to the gym or having a physical examination. These incentive systems are extremely data intensive.

Psychologists have used surveys extensively in psychometric examinations, which may give insight into a party’s likely behaviour. These surveys are however time consuming and can only be performed and interpreted by a registered psychometrist.

The concept that all of these types of behaviour evaluation have in common is that it provides hindsight only, are time consuming, and need large data sets to work optimally. In some cases, they are also prone to bias or need continuous expert input when used. There is therefore room for improvement in evaluating contracting parties’ predicted behaviour in the contractual situation.

The preceding discussion of the background to the invention is intended only to facilitate an understanding of the present invention. It should be appreciated that the discussion is not an acknowledgment or admission that any of the material referred to was part of the common general knowledge in the art as at the priority date of the application.

### SUMMARY OF THE INVENTION

According to an aspect of the present invention there is provided a computer-implemented method for evaluating entity behaviour in a contractual situation, wherein the contractual situation is between contracting entities, the method comprising: receiving initial survey input data from a user computing device on behalf of a contracting entity in the form of response data prompted by a series of questions; modelling the entity behaviour based on the initial survey input data to obtain an output predicted behaviour of the entity; receiving one or more instances of evidence input data from a data source or a user computing device relating to the contractual situation and gathered during a contractual period; and updating the modelling of the entity behaviour based on the evidence input data to migrate the output predicted behaviour to an output evidence-based behaviour.

The method may include formulating the series of questions to assess specified contractual behaviour risks and to enable effective rendering on a user computing device. The response data prompted by a series of questions may include at least some of the response data augmented with reaction-based metadata. The method may also include controlling an effect of the reaction-based metadata on the modelling by applying a weighting allocation to metadata of response data.

The method may include receiving subsequent survey input data from a user computing device in the form of additional response data prompted by a series of questions with at least some of the response data augmented with reaction-based metadata. The subsequent survey input data may be from a user computing device on behalf of a contracting entity or from a user computing device of a third party.

Receiving one or more instances of evidence input data may include event driven survey input data in response to an event driven survey from or on behalf of a contracting entity or other entity related to the contractual situation.

The modelling may apply one or more of the group of: a machine learning modelling approach; a probabilistic modelling approach with a probability that the entity’s behaviour is acceptable with defined error bands; and a heuristic modelling approach including statistical modelling and/or mathematical modelling. The modelling may include outputting entity behaviour categorised in a plurality of subsets of behaviour characteristics or risk categories.

The method may generate an object score for an object to which the contractual situation relates, wherein the object score is a result modelled behaviour of one or more contracting entity.

The method may include providing output results of the modelling periodically to the user computing device as an incentive for actual behaviour of the entity. The method may further include providing interpretable output results that provide an indication via subsets of behaviour characteristics of what has caused a given result; and prompting an input of additional input data to clarify the output results. The method may include providing output results that include an uncertainty range in the behaviour characteristics and distribution of behaviour under predefined conditions.

The method may be carried out at server-side software that receives input data from client-side software on user or third party computing devices. The method may include instructing the client-side software to capture reaction data for reaction-based metadata when receiving survey input data from a user.

According to another aspect of the present invention there is provided a computer-implemented method for evaluating entity behaviour in a contractual situation over time, carried out by a modelling system and comprising: inputting survey input data in the form of response data gathered from a user representing the entity in the form of response data prompted by a series of questions; inputting evidence input data from data sources relating to the contractual situation and gathered during a contractual period; and modelling entity behaviour based on the survey input data and the evidence input data to migrate an output predicted behaviour to an output evidence-based behaviour over time.

The method may include machine learning modelling of entity behaviour by applying a probabilistic approach with a probability that the entity’s behaviour is acceptable with defined error bands. The method may additionally or alternatively include heuristic modelling of entity behaviour includes combining data points from the evidence input data with response data and the reaction-based metadata.

The method may include scoring a category of entity behaviour on a range from acceptable to unacceptable behaviour based on machine learning using objective response data from other users.

According to a further aspect of the present invention there is provided a system for evaluating entity behaviour in a contractual situation, wherein the contractual situation is between contracting entities, the system including a memory for storing computer-readable program code and a processor for executing the computer-readable program code, the system including a server comprising: a survey input data receiving component for receiving initial survey input data from a user computing device on behalf of a contracting entity in the form of response data prompted by a series of questions; an evidence based data receiving component for receiving evidence input data from data sources or user computing devices relating to the contractual situation and gathered during the contractual period; and a modelling system for modelling the entity behaviour using a behaviour model based on the initial survey input data to obtain an output predicted behaviour of the entity and updating the modelling of the entity behaviour based on the evidence input data to migrate the output predicted behaviour to an output evidence-based behaviour.

The system may include a survey formulation component for formulating the series of questions to assess specified contractual behaviour risks and to enable effective rendering on a user computing device. The system may include a survey providing component for providing a survey to a user computing device including reaction capturing instructions to be applied when receiving survey input data.

The system may include a reaction metadata component for receiving response data prompted by a series of questions including at least some of the response data augmented with reaction-based metadata. The system may include a metadata weighting component for controlling an effect of the reaction-based metadata by applying a weighting allocation to metadata of response data.

The survey input data receiving component may receive updated survey input data from the user computing device or from a third party computing device at one or more times during the time period in the form of additional response data prompted by a series of additional questions and the measurement of the user’s reaction time for at least some of the response data; and the modelling system updates the modelling of the entity behaviour based on the updated survey input data.

The evidence input data receiving component may receive evidence input data from the user computing device and/or a third party computing device including event driven survey input data in response to an event driven survey from or on behalf of a contracting entity or other entity related to the contractual situation.

The modelling system may include machine learning modelling of entity behaviour by applying a probabilistic approach with a probability that the entity’s behaviour is acceptable with defined error bands. The modelling system may include heuristic modelling of entity behaviour includes combining data points from the evidence input data with response data and the reaction-based metadata.

The system may include an output component for providing output results of the modelling categorised in a plurality of subsets of behaviour characteristics or contractual risk categories.

The output component may provide output results of the modelling periodically to the user computing device. The output component may provide interpretable output results that provide an indication via subsets of behaviour characteristics of what has caused a given result; and a feedback component may prompt an input of additional input data from the user computing device to clarify the output results.

The system may be carried out at a server that receives input data from client-side software on user or third party computing devices. The server may be a cloud-based server that receives input data from progressive web applications of one or more remote computing devices.

According to a further aspect of the present invention there is provided a computer program product for evaluating entity behaviour in a contractual situation, wherein the contractual situation is between contracting entities comprising a computer-readable medium having stored computer-readable program code for performing the steps of: receiving initial survey input data from a user computing device on behalf of a contracting entity in the form of response data prompted by a series of questions; modelling the entity behaviour using a behaviour model based on the initial survey input data to obtain an output predicted behaviour of the entity; receiving one or more instances of evidence input data from a data source or a user computing device relating to the contractual situation and gathered during a contractual period; and updating the modelling of the entity behaviour based on the evidence input data to migrate the output predicted behaviour to an output evidence-based behaviour

Further features provide for the computer-readable medium to be a non-transitory computer-readable medium and for the computer-readable program code to be executable by a processing circuit.

Embodiments of the invention will now be described, by way of example only, with reference to the accompanying drawings.

### BRIEF DESCRIPTION OF THE DRAWINGS

In the drawings:

FIG. 1 is a schematic diagram of an example embodiment of the described system;

FIG. 2 is a flow diagram illustrating an example embodiment of the described method and system;

FIG. 3 is a flow diagram illustrating an example embodiment of the described method; and

FIG. 4 illustrates an example of a computing device in which various aspects of the disclosure may be implemented.

### DETAILED DESCRIPTION WITH REFERENCE TO THE DRAWINGS

A system is described with an associated computer-implemented method in which input data is defined, gathered and input into a modelling system to model predicted behaviour of an entity in a contractual situation. A contractual situation may include a written, verbal or implied contract for a service. Contracting entities may be an individual, a group of individuals, a company, other organisation, or legal entity. Entities involved in the contract may further extend to physical entities or objects such as a property, policy, etc.

The input data may be a layered form of inputs in the form of initial survey input data, update survey input data, and evidence input data. The input data may be gathered relating to an entity in the contractual situation as well as from other sources related to the entity, including sources providing evidence of an entity’s actual behaviour. Evidence input data may be input during the contractual period and may include documented evidence and/or additional event-driven survey input data. As a result of the update survey input data and evidence input data that is input over time, the predicted behaviour output from the model migrates towards actual behaviour supported by the evidence input data.

Survey input data is obtained based on the formulation and maintenance of specific survey input requirements to enable the successful modelling of the entity’s behaviour and the rendering of this survey input data from a user computing device. Survey input data may be augmented in some responses of a survey with reaction-based metadata obtained from measured physical reactions of the user providing the response data.

The quality of the survey input data directly impacts the efficacy of the behavioural modelling and relevance of the output provided to the users of the system. The method applied to formulate and maintain the questions that are included in surveys used to generate survey input data is of value to the quality of the survey input data. This includes but is not limited to one or more of: using expert knowledge of the contractual scenario to define the risk areas that should be evaluated; using expert knowledge to phrase the questions in such a way that the required responses are triggered; ensuring that the structure of the questions align to the input requirements of the behavioural model; and evaluating the behavioural output in context of the risks being evaluated. It also includes the formulation of questions as short interviews, without any reaction-based measurement being used.

At least part of the question formulation process may be automated. Automation of the process enables it to be rendered quickly in comparison to other methods such as psychometrics or other behaviour models that need a huge amount of input data to be effective.

The survey input data includes response data to a series of questions with some of the response data augmented with reaction-based metadata. The reaction-based metadata may be based on a weighting allocation determined as part of the modelling system requirements for a specific contractual situation. The reaction-based metadata may be generated automatically at a user computing device by measuring a user’s reaction to a question. This may ensure that a multilayered reaction may be captured to increase the accuracy of the behaviour model over time. As examples, the measurement may be: a reaction time, a recorded facial expression, voice monitoring, gaze tracking, or other device information or demographics at the time of the survey response.

The output of the model may identify results that are uncertain or mid-range and which may be improved by further input data, such as update survey input data, or additional evidence input data. The output of the model may also provide an incentive for improved actual behaviour of the user.

The behaviour evaluation aims to provide contracting entities with the relevant relationship and risk management information to assess the potential risk of contracting at the initial stages of the contracting process. It also provides ongoing risk information for the entities to assess and manage their risks throughout the contractual period. The behaviour evaluation may be provided in the form of an overall behaviour score supplemented by sub-section information that provides more insights into the different areas of risk that are measured.

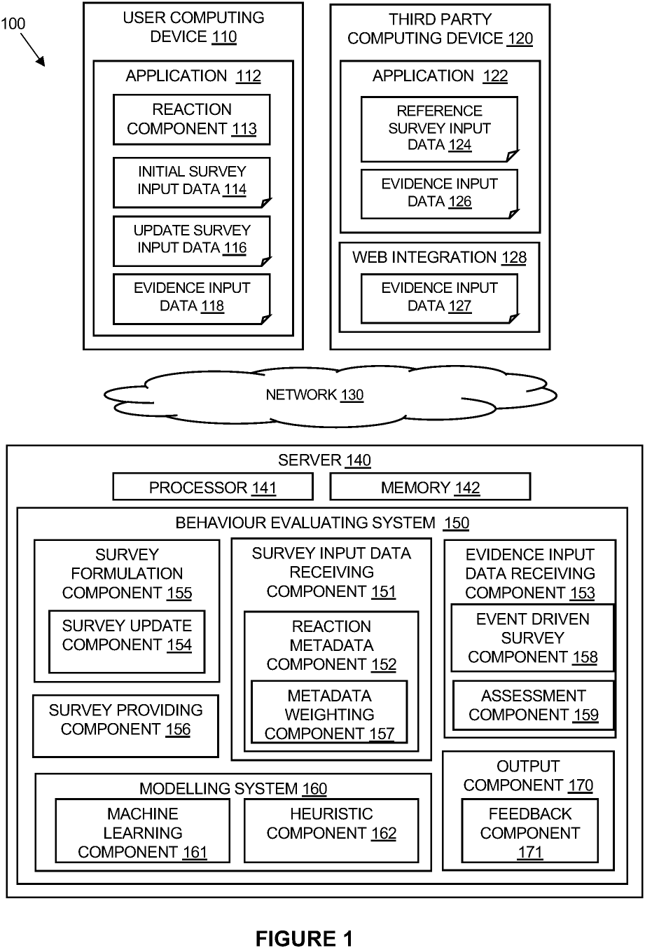

Referring to FIG. 1, a schematic diagram (100) shows an example embodiment of a system implementing the described method and system. A server (140) provides a backend to a behaviour evaluating system (150) provided as a remote service for evaluating an entity behaviour in a contractual situation using a modelling system (160). The server (140) may include a processor (141) for executing the functions of server-side components described below, which may be provided by hardware or by software units executing on the server. The software units may be stored in a memory component (142) and instructions may be provided to the processor (141) to carry out the functionality of the described components. The server (140) may be provided as a cloud computing implementation, having software units arranged to manage and/or process data provided remotely.

Input data is gathered from input computing devices (110, 120) at which client-side software may be provided in the form of applications (112, 122). The input computing devices (110, 120) may include a user computing device (110) of a representative of the entity or the entity itself whose behaviour is being evaluated and third party computing devices (120) from which additional data relating to the entity or the contractual situation may be input. The input computing devices (110, 120) may receive data as input by a user or may access data stored at or accessible to the input computing devices (110, 120). The gathered data may be transmitted from the input computing devices (110, 120) to the behaviour evaluating system (150) at the server (140) via a network (130).

In one example, the behaviour evaluating system (150) may be provided as a cloud-based web service that is accessed remotely via progressive web applications at the input computing devices (110, 120). A progressive web application (PWA) is a type of application software delivered through the web, built using common web technologies and it is intended to work on any platform that uses a standards-compliant browser. PWA enable creating user experiences similar to native applications on desktop and mobile devices; however, since a PWA is a web application, there is no requirement for users to install the web application via digital distribution systems. PWAs running on mobile devices can perform much faster and provide more features as well as being portable across both desktop and mobile platforms. In another embodiment, the input computing devices (110, 120) may use downloadable native software applications for gathering and inputting data.

A first form or layer of input data is survey input data (114, 116, 124) gathered from the entity being evaluated or from third parties providing information about the entity being evaluated, such as providing references or feedback relating to the entity.

The survey input data (114, 116, 124) is gathered by presenting a series of questions to a user at an input computing device (110, 120). Survey input data is obtained based on the formulation of specific survey input requirements to enable the successful modelling of the entity’s behaviour and the rendering of this survey input data from a user computing device. The behaviour evaluating system (150) may include a survey formulation component (155) for formulating survey questions using expert knowledge of a field or framework of the contractual relationship based on the specific risks that are to be evaluated in that field or framework. A survey providing component (156) may render the questions in the client-side applications (112, 122) for speed of input and with an aim of promoting a measurable reaction. The survey providing component (156) may instruct the client-side software to capture reaction data for reaction-based metadata when receiving survey input data from a user.

The survey formulation component (155) may include a survey update component (154) providing a process whereby changes in the contractual circumstances or events that influence the contract can be processed and contextualised by the formulation component and the questions to the surveys can be automatically updated. The benefit of having a survey formulation component (155) is that it will enable dynamic implementation of new surveys or changes to existing surveys going forward, it will ensure the relevance of the survey questions over time in an ever-changing environment, and it will ensure an optimisation in accuracy of the system. The survey update component (154) may also make the design loop explicit where feedback from the training model can be used to adapt and design the surveys. Feedback includes things like question importance, data importance (which data to use), model parameters, impact of global events/context, etc.

The survey input data (114, 116, 124) includes recording the response together with (when required) the reaction-based metadata obtained by a measurement of the user’s reaction when providing the response. The reaction-based metadata may be obtained at the input computing device (110, 120) or may be obtained at the server-side from raw measurement data provided from the user computing device (110, 120). The client-side application (112) may include a reaction component (113) for gathering reaction measurements at user computing device (110) and forwarding this to the server (140). The measurement at the input computing device (110, 120) may include use of the hardware and/or software components of the input computing device (110, 120), for example, a camera, a timer, a pulse monitor, a gaze tracker, a microphone, a facial recognition component, etc.

The behaviour evaluating system (150) may include a survey input data receiving component (151) that includes a reaction metadata component (152). An example of how reaction metadata can be measured as part of the survey input data receiving component (151) is described in U.S. Pat. No. 10,043,411. The reaction metadata component (152) may include a metadata weighting component (157) for controlling an effect of the reaction-based metadata by applying a weighting allocation to metadata of response data.

The questions in a survey may relate to convictions of the user relating to roles and responsibilities of the entity in the contractual situation. Initial survey data (114) may be gathered from an entity at the initial stages of contracting and the questions are designed to provide insight into the pre-existing convictions of a user representative of the entity that completed the survey on the risks related to the contract. The responses provide an indication of the most likely behavioural outcomes to expect from that entity during the contracting period. An initial survey may be responded to via the application (112) on a user computing device (110) of the entity.

Update survey input data (116) may be gathered from the entity at times during a contractual term, for example, at regular intervals or as required. The entity may respond to a prompt to provide update survey data by repeating the initial survey or by carrying out a different survey. A third party may also provide survey input data, for example, in the form of reference survey input data (124) relating to the third party’s interaction with the entity. The third party may be invited to input data and may be provided with permission to provide information for the entity.

In addition to the survey input data, the system may also gather evidence input data (118, 126, 127) from either or both the entity or a third party. The behaviour evaluating system (150) may include an evidence input data receiving component (153) that may receive uploaded or input evidence data from the application (112, 122) or by a web integration (128) of the data resource into the behaviour evaluating system (150) or by another suitable method. For example, the evidence input data (126) provided by a third party may relate to financial records provided by a bank, or a credit rating provided by a credit bureau, policy data, police or court records provided by authorities. Such evidence input data (126) may be provided from a third party with permission from the entity to support their evaluation. The evidence input data (118, 126, 127) may be provided in conjunction with the initial survey input data, for example, to correlate some evidence data to initial survey input data. The evidence input data (118, 126, 127) may also be provided, updated, and/or supplemented during the contract term to provide an increasing amount of concrete data relating to the entity’s behaviour.

The evidence input data receiving component (153) may include an event driven survey component (158) for evaluating survey information. The evidence input data receiving component (153) may include an assessment component (159) for assessment of the evidence based input data (118, 126) that may be carried out using machine learning (for example, object recognition) or other processing before this data is provided to the modelling system (160) to update the behavioural assessment for each of the contractual entities. The evidence based input data (118, 126) may also be used to provide a contract object score of one or many of the contractual objects defined in relation to the contractual relationship (for example: a condition of a rental property). This score may then be used as input to adjust the behavioural scores of the different contracting entities (e.g. tenant, agent or landlords).

The evidence based input data (118, 126) may also include input data from event driven evidence based surveys. This may be a different type of survey that is focused on specific events that occur during a contractual relationship where specific evidence is captured. An example of such a survey that is an inspection survey to be conducted by one of the contractual entities such as the agent and approved by the other entity (i.e. tenant). The evidence captured may be a combination of images, questions (for example, a yes/no answer or a score on a scale), and checklists.

Any of the different forms of survey input data may be augmented with reaction-based metadata, if appropriate. However, it may not be appropriate to provide reaction-based metadata to some of the survey questions particular in event-driven surveys.

The gathered input data may be provided to the modelling system (160) that may be provided at the server (140) integrated with the behaviour evaluating system (150) or that may be provided remotely to the server (140). The modelling system (160) may provide an output via an output component (170) of the behaviour evaluating system (150). A feedback component (171) may also be provided where the output indicates that additional input data is needed to evaluate the output.

Further details on the modelling system (160) are provided below and this may include one or more of multiple different modelling components using different modelling methods including a machine learning component (161) and/or a heuristic modelling component (162). The modelling system (160) may be an ensemble of models, where some models may be heuristic rules, mathematical functions or mappings, or statistical models. This allows for all processing of data including pre-processing (which is understood as just a mathematical transformation of the data so that the data is suitable for modelling purposes). It also allows for optimisation of several possible pre-processing steps (normalisation or combination of normalisations of the data), in cases where the normalisation of data can have an impact on the accuracy of the results.

An ensemble or combination of models may be provided within the overall machine learning framework and this may be adjusted depending on the contractual situation being evaluated and the available input data linked to the situation. This may include more heuristic models such as statistical modelling and mathematical modelling. The benefit of including these models is that more focussed “interviews” may be conducted with entities to obtain focussed data where the use of reaction-based measurement surveys may be too protracted for the users. Depending on the contractual situation and the behaviour risks being evaluated as well as the appropriateness or reliability of the response metadata, the inclusion or importance of the reaction-based response metadata may be controlled using a weighting allocation. This weighting can be adjusted between 0 and 1, where 0 means no response metadata is used and 1 means all of the metadata is used in the modelling system (160).

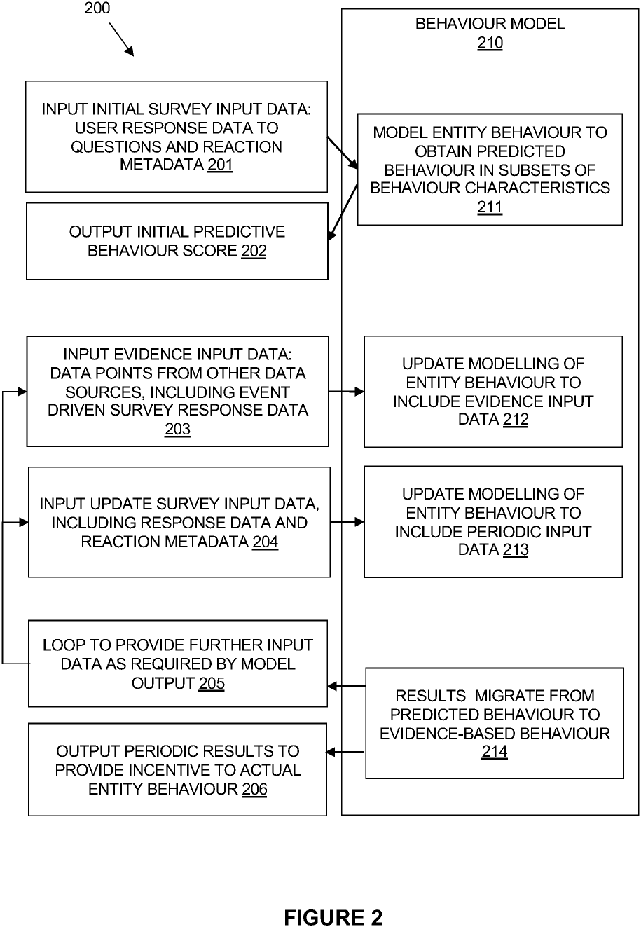

Referring to FIG. 2, a flow diagram (200) shows an example embodiment of input data and modelling as provided by the described method and system. The flow diagram (200) shows a behaviour model (210) for modelling entity behaviour with initial survey input data (201) input from a user computing device (110). For example, this may be a computing device (110) of a user representing an entity to a contractual situation. The survey may be performed on any computing device (110) (for example, a desktop, a laptop, a tablet, a mobile phone). The initial survey input data (201) may be response data to a series of questions and metadata based on a measurement of the user’s reaction for at least some of the response data depending on the weighting allocation determined by the modelling system (160).

The form of the initial survey questions may be dependent on the field of the contractual situation and may relate to convictions of the user relating to the roles and responsibilities of the contractual situation. The question responses may be yes/no answers or may be a scale of response, for example, 1 to 5. The reaction of a user in responding to a question is recorded with the response data. The reaction may be analysed to provide reaction-based metadata as an input into the behaviour model (210).

The initial survey input data in the form of the response data and reaction measurements may be used to generate an initial predictive behaviour score (202) that provides an initial indication of an entity’s behaviour. This initial predictive behaviour score (202) may be output from the behaviour model (210). The behaviour model (210) receives the initial survey input data (201) that may be augmented with reaction-based metadata that may be weighted and models (211) entity behaviour to obtain the initial predictive behaviour score of the entity to the contractual situation. This may use the different modelling methods described above, including optionally using objective response data from other users.

The modelling may use a single model or an ensemble of models. The ensemble of models may be within an overall machine learning framework and may include a probabilistic approach to modelling with a probability that the entity’s behaviour is acceptable with defined error bands. The modelling may include subsets of behaviour characteristics for which results are modelled as well as an overall score. The modelling provides interpretable outputs that provide an indication via the subsets of behaviour characteristics of what has caused a given outcome. This enables a mid-range score or uncertain score to be further investigated by focusing further input data to be input into the model. This also combats discrimination and inherent bias in data as additional input data can be questioned or refuted by obtaining further input data.

Further input data (203, 204) may be input into the behaviour model (210) before and during the contractual term. The further input data may include evidence input data (203) including data points from various data sources and including event-driven survey input data. For example, the evidence input data (203) may include financial records, testimonies, factual data, images, etc. The evidence input data (203) may be input from the computing device (110) of the entity to the contractual situation or from a computing device (120) of a third party, which may be an organisation, an individual, a regulator, etc.

The modelling of the entity behaviour by the behaviour model (210) may be updated (212) in response to receiving evidence input data. This may be combined with the survey input data to model the entity behaviour more accurately and migrate the modelling from a predicted entity behaviour to an actual entity behaviour based on the evidence input data received into the model over time. This provides an adaptive model that updates the behaviour prediction over a period of time.

Further input data may also include update survey input data (204) including response data and reaction-based metadata data similar to that of the initial survey input data. The initial survey may be repeated and updated, or additional surveys may be provided to the user representing the entity for completion at times during the contractual term. The update survey input data may be provided by the entity to the contractual situation and/or by third parties, such as reference providers or other involved entities in the contractual situation.

The modelling of the entity behaviour by the behaviour model (210) may be updated (213) in response to receiving update survey input data. This may be combined with the initial survey input data and the evidence input data to model the entity behaviour more accurately over time.

The results (214) of the behaviour model (210) may be output at different times during the contractual term to update the output results and these may migrate from predicted behaviour to evidence-based or actual behaviour due to the augmented evidence input data and updated survey input data. In this way, the output results (214) are fluid and dynamic based on the available input data including evidence-based data. The output results may indicate that additional input data is required in particular areas. The output results may include subsets of behaviour characteristics for which results are modelled as well as an overall score and additional input data may be required for a particular subset where the result is unexpected or uncertain. This may activate a loop (205) to prompt further evidence input data (203) and/or update survey input data (204). The output results (206) provided during the contractual term, for example, periodically, may also provide an incentive to the entity of the contractual situation to improve or maintain their acceptable behaviour relating to the situation.

The results (206) are therefore supplemented over the contracting period with a combination of other data sources, some of which are evidence based and some that consist of follow-up surveys. The model calculates and updates the overall score and/or subset behaviour characteristic scores to indicate whether the initial behaviour risk increased or decreased and therefore serves as an early warning mechanism to mitigate issues during the contracting period. The results are designed such that do not require any support from psychometrists or other specialists to interpret the results provided.

The modelling of entity behaviour may be carried out for specific entities or all entities that are party to a contractual situation where an entity may be an individual, a group of individuals, a company, other organisation, or legal entity. A user inputting the input data on behalf of an entity to a contractual situation via a user computing device (110, 120) may be authorised to act and provide information for the entity.

The described method is more dynamic than known survey methodologies and is able to adapt to different contractual situations or events that could affect situations, such as financial market crashes, pandemics, etc.

The described method provides simpler surveys that when used within evaluation methods can adapt dynamically to changes in contractual situations and align to specific risk factors that are prevalent for the specific contractual type. The described method and system can also contextualise a specific user’s situation in a more reasonable amount of time, which means that users will not always be required to answer all the related questions for a specific scenario which will save users a significant amount of time.

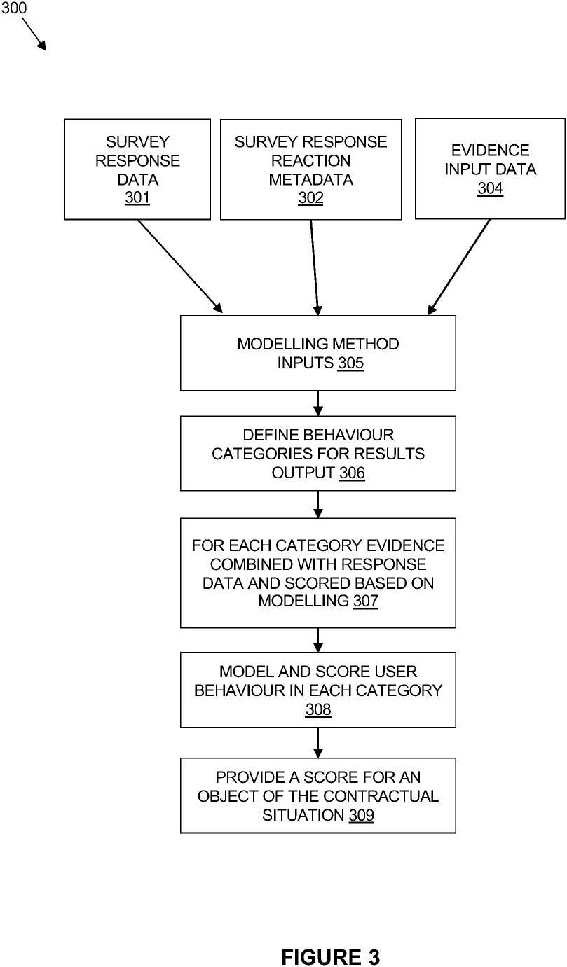

Referring to FIG. 3, a flow diagram (300) shows an example embodiment of a modelling method used in the described method and system. As discussed in relation to FIG. 2, the modelling method may receive inputs (305) of survey response data (301), reaction-based metadata of survey response data (302), and evidence input data (304).

Behaviour categories may be defined (306) for the required results outputs. These categories may vary based on the field or domain of the contractual situation for which behaviour is being modelled. The evidence input data (304) may be combined (307) with response data (301) for a defined category prior to or during the modelling.

Assessments of the evidence input data (304) may be carried out using machine learning or other processing before this data is provided to the modelling method to update a behavioural assessment for each of the contractual entities. The evidence input data (304) may also be used to provide a score of one or many of contractual items defined in relation to the contractual relationship (for example: a condition of a rental property).

In one embodiment, the modelling (308) is carried out by a behaviour model that is trained from a training set of entity behaviour data and based on a probabilistic model for each defined category. The output of the modelling (308) may be a score or range of scoring for each defined category allowing interpretation of the output results and determination of input data that causes output results.

The modelling may also be used to compute an object score (309) for an object of the contractual situation, for example, a property or a policy. The object score may be for an object to which the contractual situation relates and may be a result modelled behaviour of one or more contracting entity involved in the contractual situation. In the case of a property contractual situation, a property score may be a consistent score indicating the property’s condition and maintenance with the underlying assumption that people are ultimately responsible for the condition of the property. The score can also be broken down into subparts that can be linked to behaviour of the entities involved and fed back into the model to update the scores of the entities involved.

Example embodiments of contractual situations to which the described method and system may be applied are in the domains of property, life, health and insurance industries, investment and banking industries. Parties contracting in these industries benefit from having a solution that provides insights into counterparties’ expected behaviour before these parties start the contracting process. In the property, general insurance and banking industries credit checks are used as a tool to determine basic historic information such as payment history and criminal offences. It has however been proven in many cases to discriminate unfairly and the risks measured in credit checks do not align to all the risks that a contracting party would like to assess. For instance, in the property industry, it does not address property damage caused by a tenant.

In the insurance industry, it does not cover potential of submitting a fraudulent claim.

In an example of the residential property industry, some of the biggest risks are: non-payment of rent, property damage, and adhering to the various applicable legal requirements. In an example of the insurance industry, one of the main concerns would be determining the insurability of a property or a person. The root causes of all of these risks are behavioural in nature and link to the convictions of each of the parties around their roles and responsibilities within a specific contract.

Using the described method and system and focusing on property rental specifically, when a tenant applies for a renting contract, the agent or landlord may provide the tenant with an invitation to the behaviour evaluating system provided via a web application accessible via the tenant’s computing device to a short survey focusing on renting. The behaviour evaluating system then calculates an initial score for the tenant based on the most appropriate categorisation for the renting industry.

The score therefore provides the agent or landlord with the most likely behaviour to expect from the tenant under normal circumstances. Over the lease term, follow-up surveys may be conducted and other data is sourced through interaction with the behaviour evaluating system to update the score to then reflect actual behaviour during the lease period. The score is therefore a continuously updated behavioural indicator that will incentivise the tenant to behave appropriately when renting a property. The score may be made available to new agents should the tenant decide to move to a new property.

The same principle applies to scoring other entities relating to rental contracts enabling them to obtain a better understanding of what to reasonably expect from the each other in terms of behaviour during the rental contract.

Evidence input data may include an event driven survey, for example, property maintenance can be measured via an inspection survey. Contractual obligations may be quantified in the form of a checklist survey and a score for the property that can then be computed within the described framework with one or more categories that quantify the responsibilities of, for example, 1) landlords, 2) agents, 3) tenants, and 4) service providers that were involved during maintenance. The latter score for each party is indicative of behaviour and can then be migrated back into the overall behaviour score for each party. A property score may be a combined score that is indicative of behaviour of all parties involved. The property score may also give agents, landlords, and tenants a better understanding of the key elements of the property that they are interested in renting or managing.

The model determines the significance of each question or additional data point provided to the outcome of each measurement area on a continuous basis and therefore allows for regional or industry specific applications as well as cyclical expectations during a contract period.

The described framework captures and stores various datasets that can be used to assess a tenant’s behaviour in the context of real estate. The goal is to shift the focus from credit worthiness to be more behavioural orientated. A tenant can be “rated” using various datasets to form a global picture of a tenant. In the context of real estate various potential behavioural issues can be detected, e.g., property damage, conflict with neighbours, etc.

A score for a tenant may be subdivided into various categories, as mentioned above and behaviour may be assessed in these categories as well as a final behaviour score. The same method and scoring may be applied to agents, landlords, or properties to cover all different angles in the prediction model.

As a score may have a strong influence on a person’s housing, it is important to make sure that the score is an accurate representation of a person’s behaviour and to indicate when the score should not be trusted (e.g., if there is not enough data to make a conclusion) and where further input data is required.

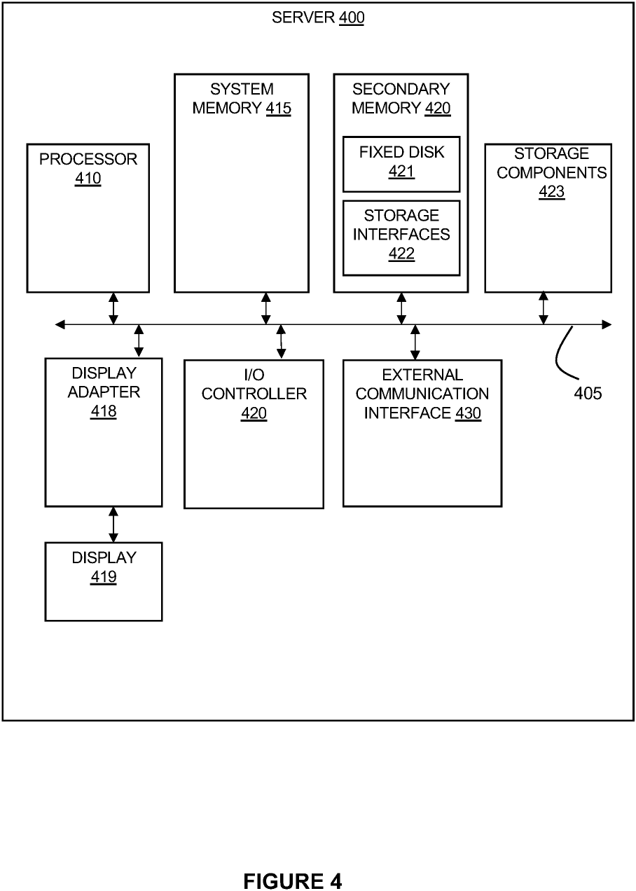

FIG. 4 illustrates an example of a computing device (400) in which various aspects of the disclosure may be implemented, including the server (140), the user computing device (110), and the third party computing device (120). The computing device (400) may be embodied as any form of data processing device including a personal computing device (e.g. laptop or desktop computer), a server computer (which may be self-contained, physically distributed over a number of locations), a client computer, or a communication device, such as a mobile phone (e.g. cellular telephone), satellite phone, tablet computer, personal digital assistant or the like. Different embodiments of the computing device may dictate the inclusion or exclusion of various components or subsystems described below.

The computing device (400) may be suitable for storing and executing computer program code. The various participants and elements in the previously described system diagrams may use any suitable number of subsystems or components of the computing device (400) to facilitate the functions described herein. The computing device (400) may include subsystems or components interconnected via a communication infrastructure (405) (for example, a communications bus, a network, etc.). The computing device (400) may include one or more processors (410) and at least one memory component in the form of computer-readable media. The one or more processors (410) may include one or more of: central processing units (CPUs), graphical processing units (GPUs), microprocessors, field programmable gate arrays (FPGAs), application specific integrated circuits (ASICs) and the like. In some configurations, a number of processors may be provided and may be arranged to carry out calculations simultaneously. In some implementations various subsystems or components of the computing device (400) may be distributed over a number of physical locations (e.g. in a distributed, cluster or cloud-based computing configuration) and appropriate software units may be arranged to manage and/or process data on behalf of remote devices.

The memory components may include system memory (415), which may include read only memory (ROM) and random access memory (RAM). A basic input/output system (BIOS) may be stored in ROM. System software may be stored in the system memory (415) including operating system software. The memory components may also include secondary memory (420). The secondary memory (420) may include a fixed disk (421), such as a hard disk drive, and, optionally, one or more storage interfaces (422) for interfacing with storage components (423), such as removable storage components (e.g. magnetic tape, optical disk, flash memory drive, external hard drive, removable memory chip, etc.), network attached storage components (e.g. NAS drives), remote storage components (e.g. cloud-based storage) or the like.

The computing device (400) may include an external communications interface (430) for operation of the computing device (400) in a networked environment enabling transfer of data between multiple computing devices (400) and/or the Internet. Data transferred via the external communications interface (430) may be in the form of signals, which may be electronic, electromagnetic, optical, radio, or other types of signal. The external communications interface (430) may enable communication of data between the computing device (400) and other computing devices including servers and external storage facilities. Web services may be accessible by and/or from the computing device (400) via the communications interface (430).

The external communications interface (430) may be configured for connection to wireless communication channels (e.g., a cellular telephone network, wireless local area network (e.g. using Wi-Fi™), satellite-phone network, Satellite Internet Network, etc.) and may include an associated wireless transfer element, such as an antenna and associated circuitry.

The computer-readable media in the form of the various memory components may provide storage of computer-executable instructions, data structures, program modules, software units and other data. A computer program product may be provided by a computer-readable medium having stored computer-readable program code executable by the central processor (410). A computer program product may be provided by a non-transient or non-transitory computer-readable medium, or may be provided via a signal or other transient or transitory means via the communications interface (430).

Interconnection via the communication infrastructure (405) allows the one or more processors (410) to communicate with each subsystem or component and to control the execution of instructions from the memory components, as well as the exchange of information between subsystems or components. Peripherals (such as printers, scanners, cameras, or the like) and input/output (I/O) devices (such as a mouse, touchpad, keyboard, microphone, touch-sensitive display, input buttons, speakers and the like) may couple to or be integrally formed with the computing device (400) either directly or via an I/O controller (435). One or more displays (445) (which may be touch-sensitive displays) may be coupled to or integrally formed with the computing device (400) via a display or video adapter (440).

The foregoing description has been presented for the purpose of illustration; it is not intended to be exhaustive or to limit the invention to the precise forms disclosed. Persons skilled in the relevant art can appreciate that many modifications and variations are possible in light of the above disclosure.

Any of the steps, operations, components or processes described herein may be performed or implemented with one or more hardware or software units, alone or in combination with other devices. In one embodiment, a software unit is implemented with a computer program product comprising a non-transient or non-transitory computer-readable medium containing computer program code, which can be executed by a processor for performing any or all of the steps, operations, or processes described. Software units or functions described in this application may be implemented as computer program code using any suitable computer language such as, for example, Java™, C++, or Perl™ using, for example, conventional or object-oriented techniques. The computer program code may be stored as a series of instructions, or commands on a non-transitory computer-readable medium, such as a random access memory (RAM), a read-only memory (ROM), a magnetic medium such as a hard-drive, or an optical medium such as a CD-ROM. Any such computer-readable medium may also reside on or within a single computational apparatus, and may be present on or within different computational apparatuses within a system or network.

Flowchart illustrations and block diagrams of methods, systems, and computer program products according to embodiments are used herein. Each block of the flowchart illustrations and/or block diagrams, and combinations of blocks in the flowchart illustrations and/or block diagrams, may provide functions which may be implemented by computer readable program instructions. In some alternative implementations, the functions identified by the blocks may take place in a different order to that shown in the flowchart illustrations.

Some portions of this description describe the embodiments of the invention in terms of algorithms and symbolic representations of operations on information. These algorithmic descriptions and representations, such as accompanying flow diagrams, are commonly used by those skilled in the data processing arts to convey the substance of their work effectively to others skilled in the art. These operations, while described functionally, computationally, or logically, are understood to be implemented by computer programs or equivalent electrical circuits, microcode, or the like. The described operations may be embodied in software, firmware, hardware, or any combinations thereof.

The language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention set forth in any accompanying claims.

Finally, throughout the specification and any accompanying claims, unless the context requires otherwise, the word ‘comprise’ or variations such as ‘comprises’ or ‘comprising’ will be understood to imply the inclusion of a stated integer or group of integers but not the exclusion of any other integer or group of integers.

1. A computer-implemented method for evaluating entity behaviour in a contractual situation, wherein the contractual situation is between contracting entities, the method comprising:
receiving initial survey input data from a user computing device on behalf of a contracting entity in the form of response data prompted by a series of questions;
modelling the entity behaviour based on the initial survey input data to obtain an output predicted behaviour of the entity;
receiving one or more instances of evidence input data from a data source or a user computing device relating to the contractual situation and gathered during a contractual period; and
updating the modelling of the entity behaviour based on the evidence input data to migrate the output predicted behaviour to an output evidence-based behaviour.

2. The method as claimed in claim 1, including:
formulating the series of questions to assess specified contractual behaviour risks and to enable effective rendering on a user computing device.

3. The method as claimed in claim 1, wherein the response data prompted by a series of questions includes at least some of the response data augmented with reaction-based metadata.

4. The method as claimed in claim 3, including:
controlling an effect of the reaction-based metadata on the modelling by applying a weighting allocation to metadata of response data.

5. The method as claimed in claim 1, including:
receiving subsequent survey input data from a user computing device in the form of additional response data prompted by a series of questions with at least some of the response data augmented with reaction-based metadata.

6. (canceled)

7. The method as claimed in claim 1, wherein the modelling applies one or more of the group of: a machine learning modelling approach; a probabilistic modelling approach with a probability that the entity’s behaviour is acceptable with defined error bands; and a heuristic modelling approach including statistical modelling and/or mathematical modelling.

8. (canceled)

9. (canceled)

10. The method as claimed in claim 1, including:
providing output results of the modelling periodically to the user computing device as an incentive for actual behaviour of the entity.

11. The method as claimed in claim 1, including:
providing interpretable output results that provide an indication via subsets of behaviour characteristics of what has caused a given result; and
prompting an input of additional input data to clarify the output results.

12. The method as claimed in claim 1, including:
providing output results that include an uncertainty range in the behaviour characteristics and distribution of behaviour under predefined conditions.

13. The method as claimed in claim 1, wherein the method is carried out at server-side software that receives input data from client-side software on user or third party computing devices.

14. The method as claimed in claim 13, including instructing the client-side software to capture reaction data for reaction-based metadata when receiving survey input data from a user.

15. A system for evaluating entity behaviour in a contractual situation, wherein the contractual situation is between contracting entities, the system including a memory for storing computer-readable program code and a processor for executing the computer-readable program code, the system including a server comprising:
a survey input data receiving component for receiving initial survey input data from a user computing device on behalf of a contracting entity in the form of response data prompted by a series of questions;
an evidence based data receiving component for receiving evidence input data from data sources or user computing devices relating to the contractual situation and gathered during the contractual period; and
a modelling system for modelling the entity behaviour using a behaviour model based on the initial survey input data to obtain an output predicted behaviour of the entity and updating the modelling of the entity behaviour based on the evidence input data to migrate the output predicted behaviour to an output evidence-based behaviour.

16. The system as claimed in claim 15, including a survey formulation component for formulating the series of questions to assess specified contractual behaviour risks and to enable effective rendering on a user computing device.

17. The system as claimed in claim 15, including a survey providing component for providing a survey to a user computing device including reaction capturing instructions to be applied when receiving survey input data.

18. The system as claimed in claim 15, including a reaction metadata component for receiving response data prompted by a series of questions including at least some of the response data augmented with reaction-based metadata.

19. The system as claimed in claim 18, including a metadata weighting component for controlling an effect of the reaction-based metadata by applying a weighting allocation to metadata of response data.

20. The system as claimed in claim 15, wherein the evidence input data receiving component receives evidence input data from the user computing device and/or a third party computing device including event driven survey input data in response to an event driven survey from or on behalf of a contracting entity or other entity related to the contractual situation.

21. The system as claimed in claim 15, wherein the modelling system includes machine learning modelling of entity behaviour by applying a probabilistic approach with a probability that the entity’s behaviour is acceptable with defined error bands.

22. The system as claimed in claim 15, wherein the modelling system includes heuristic modelling of entity behaviour includes combining data points from the evidence input data with response data and the reaction-based metadata.

23. A computer program product for evaluating entity behaviour in a contractual situation, wherein the contractual situation is between contracting entities comprising a computer-readable medium having stored computer-readable program code for performing the steps of:
receiving initial survey input data from a user computing device on behalf of a contracting entity in the form of response data prompted by a series of questions;
modelling the entity behaviour using a behaviour model based on the initial survey input data to obtain an output predicted behaviour of the entity;
receiving one or more instances of evidence input data from a data source or a user computing device relating to the contractual situation and gathered during a contractual period; and
updating the modelling of the entity behaviour based on the evidence input data to migrate the output predicted behaviour to an output evidence-based behaviour.
